(19) United States
(12) Patent Application Publication
(10) Pub. No.: US 2010/0169711 A1
(43) Pub. Date: Jul. 1, 2010

(54) Method for Safely Removing an External Image Processing Device for a Computer System and Related Computer System

(76) Inventor: Yung-Yen Chang, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 12/621,480

(22) Filed: Nov. 18, 2009

(30) Foreign Application Priority Data
Dec. 30, 2008 (TW) 097151382

(51) Int. Cl. G06F 11/07

(52) U.S. Cl. 714/24; 714/E11.023

(57) ABSTRACT

A method for safely removing an external image processing device for a computer system is disclosed. The computer system is operated in a power-on mode. The method includes receiving a removing command indicating to remove the external image processing device from the computer system, asking a BIOS of the computer system to response a management message corresponding to the removing command according to the removing command, and informing an operating system of the computer system to safely remove the external image processing device according to the management message.

### BACKGROUND OF THE INVENTION

1. Field of the Invention

The present invention is related to a method for safely removing an external image processing device for a computer system and related computer system, and more particularly, to a method and related computer system capable of implementing a “hot detaching” method, to improve utilization convenience.

2. Description of the Prior Art

A notebook computer has advantages of small size, lightweight, portability, etc., and allows a user to work outside an office, to access functions of the computer system, and no longer to be bounded in front of a desk. Convenience and portability of the notebook computer allow the user to have powerful computation and documentation abilities, and enjoy complete multimedia functions anytime and anywhere.

Although the notebook computer has complete functions of a desktop computer and excellent portability, a manifest disadvantage of the notebook computer is lack of extensibility, especially for image processing schemes. Considering portability, size, weight, power consumption, heat dissipation, etc., the image processing ability of the notebook computer is usually poorer than that of the desktop computer, so that image delay or execution failure may occur when the notebook computer executes a 3D (three dimensional) game, graphics software, or other programs requiring powerful graphic ability.

In order to improve the aforementioned problems, as illustrated in FIG. 1, the prior art has disclosed an external image processing device 102 composed of an image processing chip, a heat dissipation module, etc. When a user executes programs requiring powerful graphic ability on the notebook computer 100, the user can couple the external image processing device 102 to the notebook computer 100 via a specified interface, and couple a screen 104 to the external image processing device 102, such that the external image processing device 102 can process images of the notebook computer 100, and the screen 104 can output corresponding images. Since the external image processing device 102 is not embedded in the notebook computer 100, the user can choose or purchase a suitable external image processing device 102 based on requirement, so as to improve the graphic ability of the notebook computer 100.

In the prior art, the external image processing device 102 can be coupled to the notebook computer 100 via “cold attaching” and “hot attaching”. However, when removing the external image processing device 102 from the notebook computer 100, the prior art only supports “cold detaching”, and does not support “hot detaching.” That is, when the notebook computer 100 is shut down, the user can couple the external image processing device 102 to the notebook computer 100, or remove the external image processing device 102 from the notebook computer 100. However, when the notebook computer 100 is turned on, the user can only couple the external image processing device 102 to the notebook computer 100, but cannot remove the external image processing device 102 from the notebook computer 100. If the user removes the external image processing device 102 from the notebook computer 100 without shutting down the notebook computer 100, system errors occur, leading to a malfunction of the notebook computer 100. Obviously, such operating method is inconvenient to the user, and must be improved.

### SUMMARY OF THE INVENTION

It is therefore a primary objective of the claimed invention to provide a method for safely removing an external image processing device for a computer system and related computer system.

The present invention discloses a method for safely removing an external image processing device for a computer system operated in a power-on mode, the method comprising receiving a remove command indicating to remove the external image processing device from the computer system, requesting a basic input/output system (BIOS) of the computer system to return a management message corresponding to the remove command according to the remove command, and informing an operating system of the computer system to safely remove the external image processing device according to the management message.

The present invention further discloses a computer system comprising a hardware circuit, for implementing functions of the computer system, an operating system, an external image processing device, capable of being coupled to the hardware circuit by insertion, for outputting image processing results of the hardware circuit, and a remove control device comprising a remove command generating unit, for generating a remove command indicating to remove the external image processing device from the computer system, a reception unit, for receiving the remove command, and an intermediate unit, for requesting a basic input/output system (BIOS) of the computer system to return a management message corresponding to the remove command according to the remove command.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an external image processing device of the prior art.

FIG. 2 is a schematic diagram of a process according to an embodiment of the present invention.

FIG. 3 is a schematic diagram of a remove control device according to an embodiment of the present invention.

### DETAILED DESCRIPTION

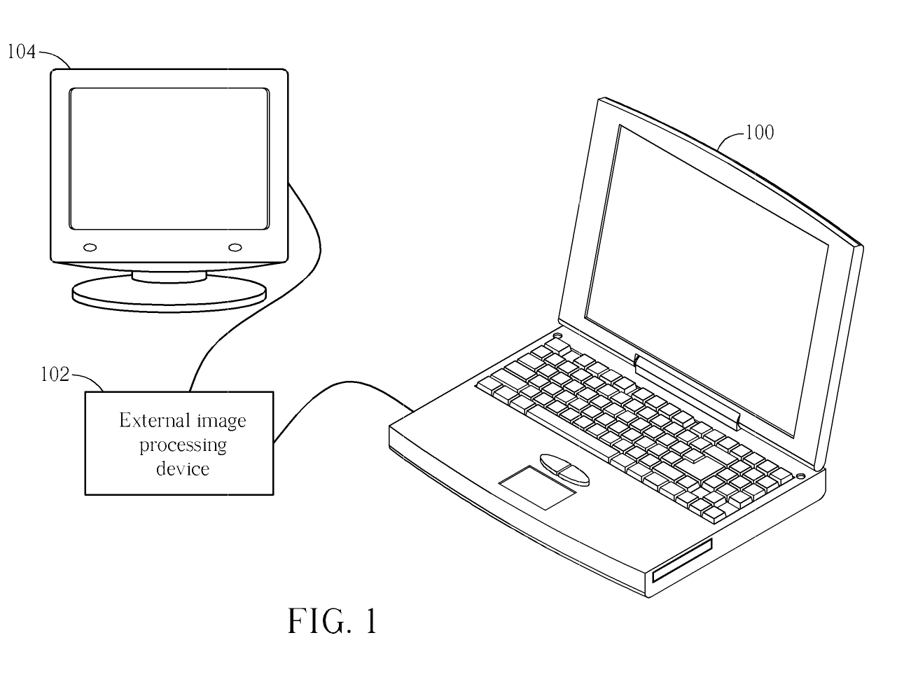

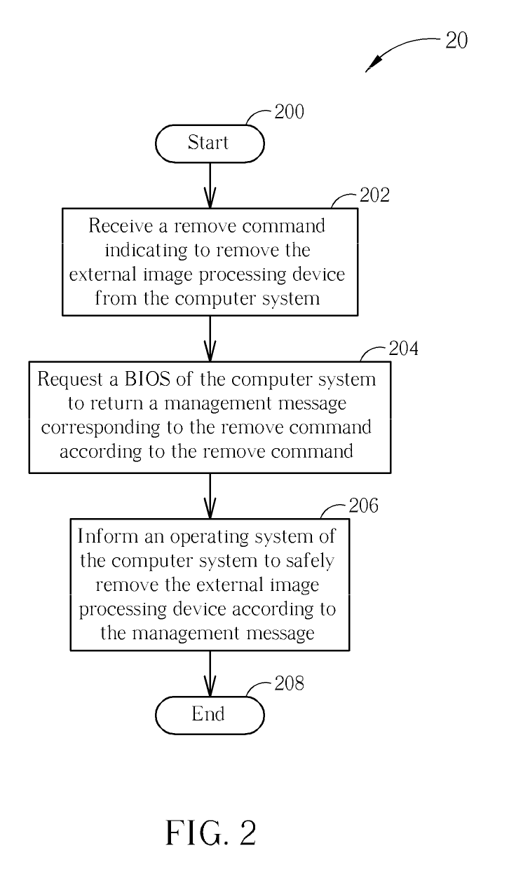

Please refer to FIG. 2, which is a schematic diagram of a process 20 according to an embodiment of the present invention. The process 20 is utilized for safely removing an external image processing device for a computer system, which is operated in a power-on mode. That is, the process 20 can remove the external image processing device 102 in FIG. 1 from the notebook computer 100 in FIG. 1 by “hot detaching.” The process 20 comprises the following steps:

Step 200: Start.

Step 202: Receive a remove command indicating to remove the external image processing device from the computer system.

Step 204: Request a basic input/output system (BIOS) of the computer system to return a management message corresponding to the remove command according to the remove command.

Step 206: Inform an operating system of the computer system to safely remove the external image processing device according to the management message.

Step 208: End.

According to the process 20, when receiving the remove command, the present invention requests BIOS to return the management message corresponding to the remove command, and accordingly informs the operating system to safely remove the external image processing device. As a result, the user can remove the external image processing device from the computer system by “hot detaching.”

Note that, the process 20 of FIG. 2 is an embodiment of the present invention, and those skilled in the art can make modifications or variations accordingly. For example, the remove command can be generated by any possible method, e.g. by pressing a keypad, by pressing a plurality of keypads, by performing a software program of the computer system, and so on. In addition, the present invention can call BIOS via an interrupt command, such as No. 10 interrupt command (INT 10) or No. 15 interrupt command (INT 15), to request BIOS to return the management message corresponding to the remove command, such as a Windows Management Instrumentation (WMI) message. Meanwhile, the present invention can further prompt the user to remove the external image processing device 102.

In the prior art, if the user removes the external image processing device 102 from the notebook computer 100 without shutting down the notebook computer 100, system errors occur, leading to a malfunction of the notebook computer 100. Compared to the prior art, in the present invention, when the user wants to “hot-detach” the external image processing device 102 from the notebook computer 100, the present invention in turn informs BIOS and the operating system, to safely remove the external image processing device 102.

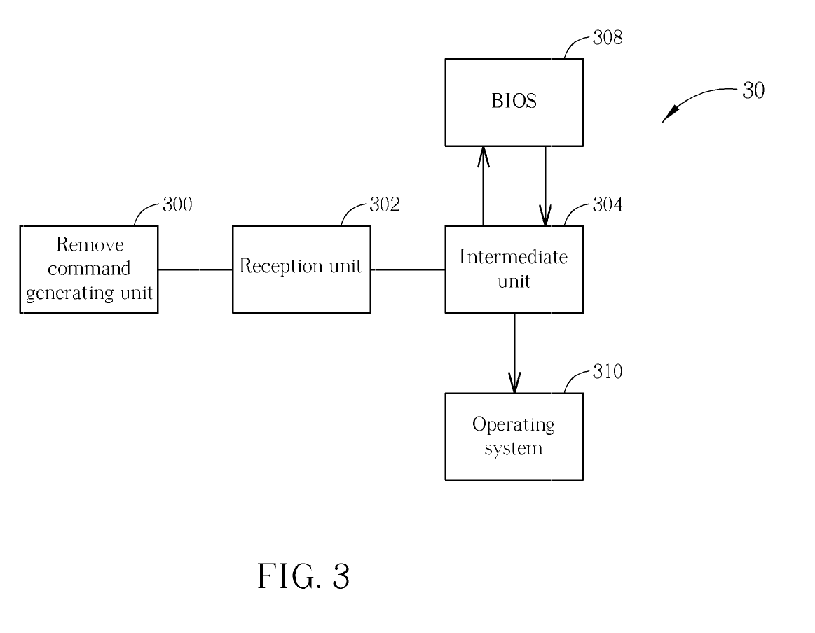

With regard to implementation of the process 20, please refer to FIG. 3, which is a schematic diagram of a remove control device 30 according to an embodiment of the present invention. The remove control device 30 is installed in a computer system. The computer system is similar to the notebook computer system 100 shown FIG. 1, and is capable of connecting the external image processing device 102 via an interface. Architecture of the computer system is well known, such that FIG. 3 only shows a BIOS 308 and an operating system 310 related to the remove control device 30, and omits other hardware circuits, such as CPU, memory, etc. The remove control device 30 comprises a remove command generating unit 300, a reception unit 302 and an intermediate unit 304. The remove command generating unit 300 can be a keypad, a combination of keypads and a software program, and is utilized for generating the remove command. The reception unit 302 is preferably a keyboard controller in the computer system, and utilized for receiving the remove command generated by the remove command generating unit 300. The intermediate unit 304 is preferably implemented by a software program, and utilized for performing Step 204 and Step 206. That is, the intermediate unit 304 requests the BIOS 308 to return the corresponding management message according to the remove command, and informs the operating system 310 accordingly, so as to safely remove the external image processing device 102. Meanwhile, the intermediate unit 304 is preferably utilized for indicating the user to remove the external image processing device 102.

The remove control device 30 of FIG. 3 is utilized for implementing the process 20, and related modifications or variations can be referred as mentioned above.

Via the architecture illustrated in FIG. 1, the user can choose the suitable external image processing device 102 according to different requirements, so as to improve the graphic ability of the notebook computer 100. However, the prior art only supports “cold detaching”, and does not support “hot detaching.” In comparison, in the present invention, even if the notebook computer 100 is powered on, the user can remove the external image processing device 102. That is, “hot detaching” can be achieved, so to enhance utilization convenience, and improve disadvantages of the prior art.

To sum up, for computer systems having external image processing devices, the present invention can achieve “hot detaching”, to enhance utilization convenience.

Those skilled in the art will readily observe that numerous modifications and alterations of the device and method may be made while retaining the teachings of the invention.

What is claimed is:

1. A method for safely removing an external image processing device for a computer system operated in a power-on mode, the method comprising:
receiving a remove command indicating to remove the external image processing device from the computer system;
requesting a basic input/output system (BIOS) of the computer system to return a management message corresponding to the remove command according to the remove command; and
informing an operating system of the computer system to safely remove the external image processing device according to the management message.

2. The method of claim 1, wherein the remove command is generated by the user pressing a keypad.

3. The method of claim 1, wherein the remove command is generated by the user pressing a plurality of keypads.

4. The method of claim 1, wherein the remove command is generated by the user performing a software program of the computer system.

5. The method of claim 1, wherein requesting the BIOS of the computer system to return the management message corresponding to the remove command according to the remove command is calling the BIOS with an interrupt command according to the remove command, to request the BIOS to return the management message corresponding to the remove command.

6. The method of claim 5, wherein the interrupt command is a No. 10 interrupt command.

7. The method of claim 5, wherein the interrupting command is a No. 15 interrupt command.

8. The method of claim 1, wherein the management message is a Windows Management Instrumentation message.

9. The method of claim 1 further comprising indicating the user to remove the external image processing device.

10. A computer system comprising:
a hardware circuit, for implementing functions of the computer system;
an operating system;
an external image processing device, capable of being coupled to the hardware circuit by insertion, for outputting image processing results of the hardware circuit; and
a remove control device comprising:
a remove command generating unit, for generating a remove command indicating to remove the external image processing device from the computer system;
a reception unit, for receiving the remove command; and
an intermediate unit, for requesting a basic input/output system (BIOS) of the computer system to return a management message corresponding to the remove command according to the remove command.

11. The computer system of claim 10, wherein the remove command generating unit is a keypad.

12. The computer system of claim 10, wherein the remove command generating unit is a combination of a plurality of keypads.

13. The computer system of claim 10, wherein the remove command generating unit is a software program.

14. The computer system of claim 10, wherein the reception unit is a keyboard controller of the hardware circuit.

15. The computer system of claim 10, wherein the intermediate unit calls the BIOS by an interrupt command, to request the BIOS to return the management message.

16. The computer system of claim 15, wherein the interrupt command is a No. 10 interrupt command.

17. The computer system of claim 15, wherein the interrupt command is a No. 15 interrupt command.

18. The computer system of claim 10, wherein the management message is a Windows Management Instrumentation message.

19. The computer system of claim 10, wherein the intermediate unit is further utilized for indicating the user to remove the external image processing device.
